(19) United States
(12) Patent Application Publication
(10) Pub. No.: US 2003/0082430 A1
(43) Pub. Date: May 1, 2003

(54) Fuel cell gasket assembly and method of making

(76) Inventor: Daisuke Suzuki, Canton, MI (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/280,816

(22) Filed: Oct. 25, 2002

Related U.S. Application Data
(60) Provisional application No. 60/351,338, filed on Oct. 25, 2001.

(51) Int. Cl. H01M 8/04

(52) U.S. Cl. 429/36; 429/39

(57) ABSTRACT

A fuel cell gasket assembly where a gas diffusion member is located in a mold, and a seal material is flowed into the mold about the perimeter of the gas diffusion member. The seal material is cured, thereby forming an integral gas diffusion member and seal. Preferably, the seal material impregnates the gas diffusion member about is perimeter. Also, an adhesive can be placed around the seal and can overlap with a portion of the gas diffusion member about its perimeter.

### CROSS REFERENCE TO RELATED APPLICATIONS

This clams the benefit of U.S. provisional patent application identified as Application No. 60/351,338, filed Oct. 25, 2001.

### BACKGROUND OF INVENTION

This invention relates in general to fluid seals, and more particularly to static gaskets for various encapsulating covers and especially fuel cells.

A fuel cell is an electrochemical energy converter that includes two electrodes that are placed on opposite surfaces of an electrolyte. In one form, an ion-conducting polymer electrolyte membrane is disposed between two electrode layers to form a membrane electrode assembly (MEA). The MEA is used to promote a desired electrochemical reaction from two reactants. One reactant, oxygen or air, passes over one electrode while hydrogen, the other reactant, passes over the other electrode. The oxygen and hydrogen combine to produce water, and in the process generate electricity and heat.

An individual fuel cell within a fuel cell assembly includes an MEA placed between a pair of separator plates. The separator plates are typically fluid impermeable and electrically conductive. Fluid flow passages or channels are formed adjacent to each plate surface at an electrode layer to facilitate access of the reactants to the electrodes and the removal of the products of the chemical reaction. In such fuel cells, resilient gaskets or seals are typically provided between the faces of the MEA and the perimeter of each separator plate to prevent leakage of the fluid reactant and product streams. Also, it is necessary to assure that the electrode layers are electrically insulated from each other. Otherwise, there can be an electrical short. The same is true with the separator plates.

Since the fuel cell operates with oxygen and hydrogen, it is important to provide a seal that not only seals well against hydrogen, oxygen and water, but that will seal well as the temperature changes due to the heat that is given off during fuel cell operation. Also, it is desirable to have a fuel cell with components that are relatively easy to assemble, while assuring the proper sealing for the finished assembly. And, the electrode layers, as well as the separator plates, need to be electrically insulated from each other.

### SUMMARY OF INVENTION

In its embodiments, the present invention contemplates an apparatus for use in a fuel cell. The apparatus includes a gas diffusion member being generally shaped as a flat plate and having a perimeter, and a gasket located about essentially the entire the perimeter of and molded integrally to the gas diffusion member.

The present invention further contemplates a method of forming a fuel cell apparatus comprising the steps of: providing a mold having a cavity with a first portion adapted for receiving a gas diffusion layer, with the gas diffusion layer having a perimeter, and a second portion extending about the perimeter for molding a seal; placing a gas diffusion layer in the mold; flowing a seal material into the second portion; curing the seal material; and removing the integral gas diffusion layer and seal from the mold.

An advantage of the present invention is that the gasket can be molded to various desired shapes while still ensuring a good seal around the entire perimeter of the gas diffusion layer and around the perimeter between the separator plates. The seal being molded to the gas diffusion layer assures that there are no tolerance build-ups between the two parts (which otherwise might exist if both are formed separately), thus assuring a good seal around the entire perimeter of the gas diffusion layer. This also allows for a good seal to be maintained, even with temperature changes that occur during fuel cell operation.

Another advantage of the present invention is that, with the gasket molded to the perimeter of the gas diffusion layer, the two integral pieces can be assembled into the unitized gasket MEA as one part, thus reducing the complexity of assembly while still assuring a good seal. Also, the gas diffusion layer will help hold the shape of the gasket during assembly, so the gasket will be located properly relative to the separator plates in order to assure a good seal between the gaskets and the separator plates.

A further advantage of the present invention is that the gasket is molded to the gas diffusion layer prior to assembly with adhesive, a catalyst and a membrane so that these three components need not be subjected to the heat of the molding process for the gasket.

Still another advantage of the present invention is that the molded gaskets and adhesive will assure that the gas diffusion layers will be electrically insulated from one another as well as the separator plates being electrically insulated from one another. This will prevent possible electrical shorts that might otherwise occur.

### BRIEF DESCRIPTION OF DRAWINGS

FIG. 1 is a schematic, sectional view of a mold containing a gas diffusion layer according to this invention.

FIG. 2 is a schematic, sectional view taken of the gas diffusion layer removed from the mold of FIG. 1 after a gasket has been molded to it according to this invention.

FIG. 3 is a schematic, sectional view of the gas diffusion layer of FIG. 2 after an adhesive has been applied according to this invention.

FIG. 4A is a schematic, sectional view of the gas diffusion layer of FIG. 3 after a catalyst has been applied according to this invention.

FIG. 4B is a schematic, sectional view of the gas diffusion layer of FIG. 2 after a catalyst has been applied according to this invention.

FIG. 5 is a schematic, exploded, sectional view of a pair of gas diffusion layers placed on opposite surfaces of a membrane.

FIG. 6 is a schematic, sectional view of a fuel cell according to this invention, incorporating the gas diffusion layers and membrane of FIG. 5.

FIG. 7 is an exploded sectional view of a second embodiment of a pair of gas diffusion layers positioned on opposite surfaces of a membrane, wherein a catalyst has been applied to the membrane instead of a gas diffusion layer.

### DETAILED DESCRIPTION

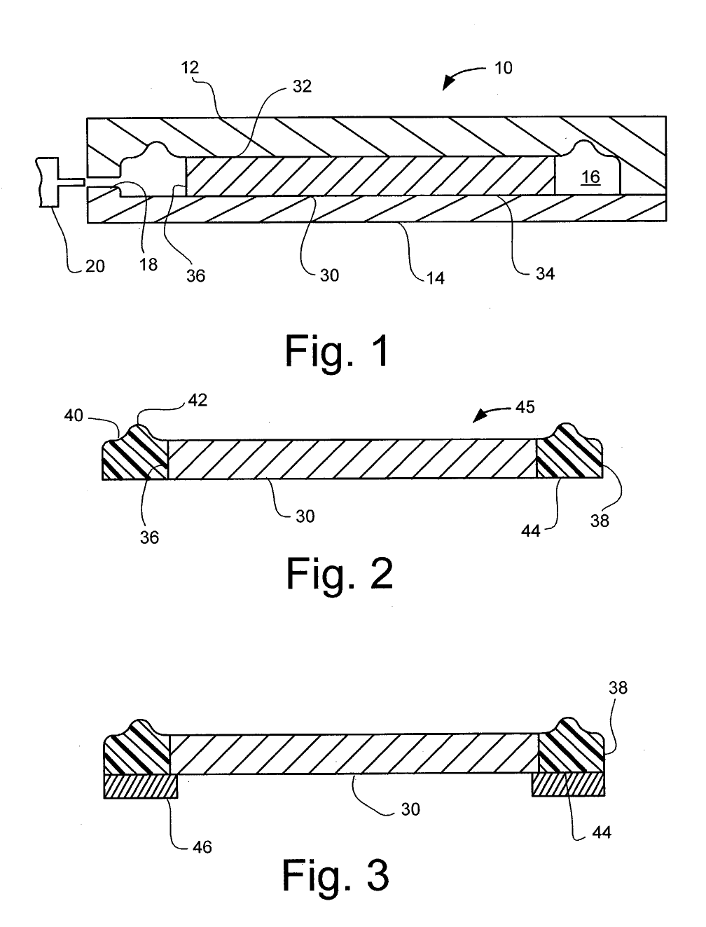

FIG. 1 illustrates a mold for making a fuel cell component which is indicated generally at 10. The mold 10 includes a first piece 12 and a second piece 14 that are fitted together so that a cavity 16 is bounded by the pieces 12 and 14. A channel 18 provides access to the cavity from the exterior of the mold 10. A tool 20 directs a moldable material into the channel 18 and cavity 16 as described below.

Prior to a gasket molding process, a gas diffusion layer 30 is formed. The gas diffusion layer may be made of, for example, a carbonized fiber, or other suitable gas permeable material for use as an electrode in a fuel cell. The process for forming the gas diffusion layer 30 will not be discussed further since it is generally known in the art. The gas diffusion layer 30 is preferably formed generally as a rectangular member having a first surface 32, a second surface 34, and a perimeter 36.

For the gasket molding process, the mold pieces 12, 14 are separated and the gas diffusion layer 30 is placed in the cavity 16. The mold pieces 12, 14 are brought together with the gas diffusion layer 30 in the mold so that the cavity 16 is formed about the perimeter 36 of the gas diffusion layer 30. The tool 20 delivers a desired moldable material through the channel 18, which, in turn, directs the moldable material into the cavity 16. The moldable material surrounds, and may also impregnate, the perimeter 36 of the gas diffusion layer 30—this forms a mechanical bond between the gasket 38 and the gas diffusion layer 30. The moldable material is then cured to form a gasket or seal 38, illustrated in FIG. 2, and removed from the mold 10. The moldable material may be, for example, rubber, or other suitable resilient sealing material.

The gasket 38 can be formed in any desired shape, as is desired for providing a good seal, including a profile with a first surface 40 having a bead 42 and a second (opposite) surface 44 that is planar. Preferably, the gasket 38 is a continuous element that spans the perimeter 36 of the gas diffusion layer 30. The gasket 38, being integrally molded to the gas diffusion layer 30, forms a one-piece seal-diffusion assembly 45.

FIG. 3 illustrates the seal-diffusion assembly 45 with an adhesive 46 that is applied to the second surface 44 of the gasket 38. The adhesive 46 is preferably a pressure sensitive adhesive that is screen printed to the gasket 38. Preferably, the adhesive 46 also extends over a portion of the second surface 34 of the gas diffusion layer 30—particularly in an area where the material of the gasket 38 may impregnate the gas diffusion layer 30.

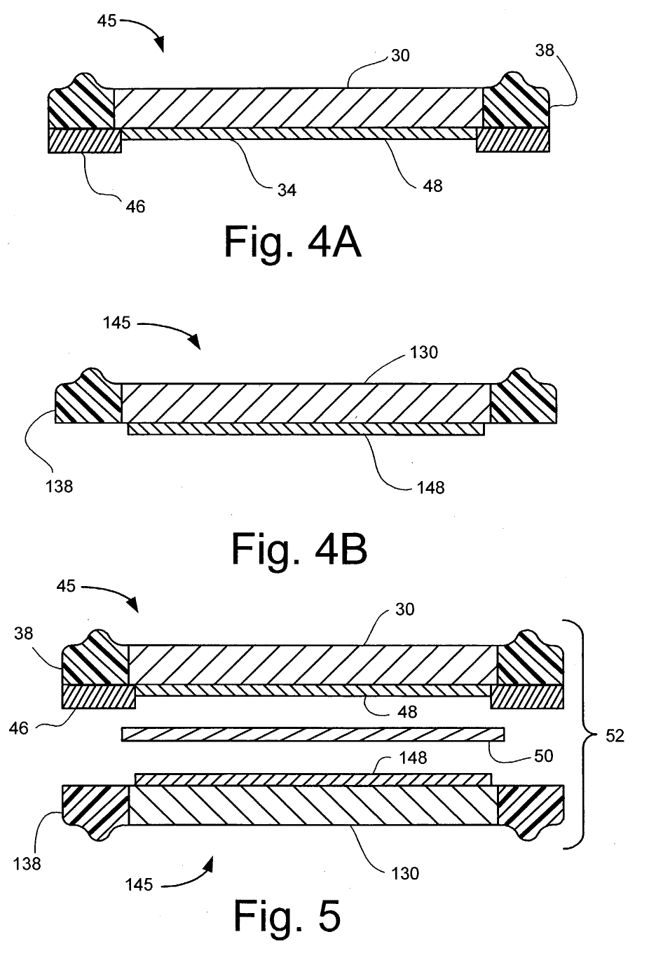

A layer of catalyst material 48 is applied to the second surface 34 of the gas diffusion layer 30, as illustrated in FIG. 4A. The catalyst material may be, for example, platinum, or any other suitable catalyst for a typical polymer electrode membrane type of fuel cell application. The catalyst material 48 can be applied by any desired means, including coating. The catalyst material 48 can be applied after the adhesive 46 is applied, or the catalyst 48 can be applied before the adhesive 46. FIG. 4B illustrates a seal-diffusion assembly 145 where a layer of catalyst material 148 has been applied to a gas diffusion layer 130 without the application of adhesive to the gasket 138.

The two seal-diffusion assemblies 45, 145 are now placed on opposite sides of a membrane 50, with the catalysts 48, 148 facing and generally aligned with the membrane 50, and the seals 38, 138 aligned around the perimeter of the assembly, as is illustrated in FIG. 5. As can be seen, at least one of the seal-diffusion assemblies 45, 145 includes the adhesive 46, although, if so desired, adhesive may be applied to both. Also, as an alternative, the adhesive may be initially applied to the membrane instead of the seal diffusion assembly. The membrane 50 is preferably an ion-conducting polymer electrolyte membrane, as generally employed in this type of fuel cell application.

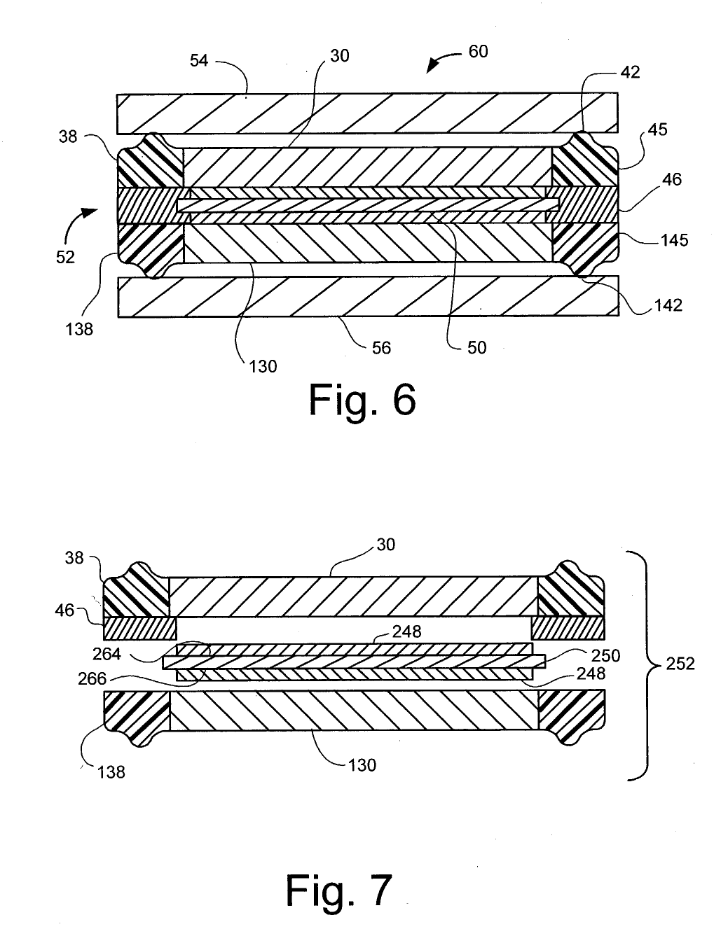

The two seal-diffusion assemblies 45, 145 are pressed together to capture the membrane 50 between the gas diffusion layers 48, 148 in order to form an assembled fuel cell component 52, as is illustrated in FIG. 6. FIG. 6 shows the fuel cell component 52 prior to the separator plates 54, 56 being fully pressed together. When complete, each separator plate 54, 56 will compress the adjacent beads 42, 142 until it its in contact with its adjacent gas diffusion layer 30, 130. The adhesive 46 flows around and adheres to the seal-diffusion assemblies around the perimeter of the membrane 50, thus holding the fuel cell component 52 together. The fuel cell component 52 is mounted between a first separator plate 54 and a second separator plate 56 to form an individual fuel cell 60. The gaskets 38, 138 and adhesive 46 provide a seal between the plates 54, 56 around the membrane 50, as well as electrically insulating the first gas diffusion layer 30 from the second gas diffusion layer 130, and the first plate 54 from the second plate 56.

The fuel cell component 52 can be characterized as a membrane electrode assembly having a unitized gasket. The structure and method presented above have advantages over the prior art. The molding process wherein the gasket 38 is integrally molded to the gas diffusion layer 30 occurs prior to the application of the adhesive 46, the catalyst 48, and the membrane 50. Thus, the adhesive 46, catalyst 48, and membrane 50 are not subjected to the heat of the molding process. Moreover, the gasket 38 is integrally molded to the perimeter of the gas diffusion layer 30, creating a good seal and allowing the two components to be assembled as a single part. Further, this sealing arrangement assures that the appropriate components are electrically insulated from one another.

A second embodiment of a fuel cell component 252, just prior to final assembly, is illustrated in FIG. 7. The fuel cell component 252 includes a membrane 250 that is coated with a layer of catalyst material 248 on both a first surface 264 and a second surface 266 of the membrane 250. A first gas diffusion layer 30 and integral gasket 38, having an adhesive 46, is placed over the first surface 264 of the membrane 250, while a second gas diffusion layer 130 and integral gasket 138 is placed over the second surface 266 of the membrane 250. The gas diffusion layers 30, 130 and gaskets 38, 138 are pressed together to capture the membrane 250 and form the fuel cell component 252. Alternatively, the adhesive can be initially applied to the membrane and catalyst material rather than the integral gasket, before assembly. This fuel cell component 252 can be substituted for the fuel cell component 52 in the individual fuel cell 60 of FIG. 6.

While certain embodiments of the present invention have been described in detail, those familiar with the art to which this invention relates will recognize various alternative designs and embodiments for practicing the invention as defined by the following claims.

What is claimed is:

1. An apparatus for use in a fuel cell comprising:
a gas diffusion member being generally shaped as a flat plate and having a perimeter; and
a gasket located about essentially the entire the perimeter of and molded integrally to the gas diffusion member.

2. The apparatus of claim 1 wherein the gasket includes an adhesive surface and wherein the apparatus further includes a layer of adhesive located about the adhesive surface.

3. The apparatus of claim 2 wherein the gas diffusion member includes a first surface and wherein the apparatus further includes a catalyst material coated on the first surface of the gas diffusion member.

4. The apparatus of claim 3 further including a membrane located adjacent to the catalyst material and a portion of the layer of adhesive.

5. The apparatus of claim 4 further including a second gas diffusion member being generally shaped as a flat plate and having a perimeter and a first surface, a second gasket located about essentially the entire perimeter of and molded integrally to the gas diffusion member, and a second catalyst material coated on the first surface of the second gas diffusion member and adjacent to the membrane, and with the second gasket having an adhesive surface in sealing contact with the layer of adhesive.

6. The apparatus of claim 1 further including a membrane having a first surface and a catalyst material coated on the first surface, with the catalyst material being adjacent to the gas diffusion member.

7. The apparatus of claim 1 wherein the gasket is made of rubber.

8. The apparatus of claim 1 wherein the gas diffusion member is made of a carbonized fiber.

9. The apparatus of claim 8 wherein a portion of the gasket is impregnated into and forms a mechanical bond with the gas diffusion member about the perimeter of the gas diffusion member.

10. The apparatus of claim 1 wherein a portion of the gasket is impregnated into and forms a mechanical bond with the gas diffusion member about the perimeter of the gas diffusion member.

11. The apparatus of claim 1 wherein the gasket includes a first surface that is generally normal to the perimeter of the gas diffusion member, and a bead projecting from the first surface about the perimeter of the gas diffusion member.

12. The apparatus of claim 1 wherein the gas diffusion member includes a first surface and wherein the apparatus further includes a catalyst material located adjacent to the first surface, and with at least a portion of the catalyst material being platinum.

13. A method of forming a fuel cell apparatus comprising the steps of:
providing a mold having a cavity with a first portion adapted for receiving a gas diffusion layer, with the gas diffusion layer having a perimeter, and a second portion extending about the perimeter for molding a seal;
placing a gas diffusion layer in the mold;
flowing a seal material into the second portion;
curing the seal material; and
removing the integral gas diffusion layer and seal from the mold.

14. The method of claim 13 wherein the step of flowing a seal material into the second portion includes flowing a rubber material into the second portion.

15. The method of claim 13 wherein the step of placing a gas diffusion layer into the mold includes placing a carbonized fiber gas diffusion layer into the mold.

16. The method of claim 13 further including the step of allowing the seal material to impregnate the perimeter of the gas diffusion layer prior to completing the step of curing the seal material.

17. The method of claim 13 further including the step of locating an adhesive material on a portion of the integral gas diffusion layer and seal adjacent to the perimeter of the gas diffusion layer, after the step of curing the seal material.

18. The method of claim 13 further including the step of locating a catalyst material adjacent to and in contact with a side of the gas diffusion layer, after the step of curing the seal material.

19. The method of claim 18 further including the step of locating a membrane adjacent to and in contact with the catalyst material.

20. A method of forming a fuel cell apparatus comprising the steps of:
providing a mold having a cavity with a first portion adapted for receiving a gas diffusion layer, with the gas diffusion layer having a perimeter, and a second portion extending about the perimeter for molding a seal;
placing a gas diffusion layer in the mold;
flowing a seal material into the second portion;
allowing the seal material to impregnate the perimeter of the gas diffusion layer;
curing the seal material; and
removing the integral gas diffusion layer and seal from the mold.
